(19) United States
(12) Patent Application Publication
(10) Pub. No.: US 2013/0241420 A1
(43) Pub. Date: Sep. 19, 2013

(54) DYNAMIC LIGHTING CONTROL

(71) Applicants: László BALÁZS, Godollo (HU); Bertalan Kercsó, Budapest (HU); István Maros, Budapest (HU)

(72) Inventors: László BALÁZS, Godollo (HU); Bertalan Kercsó, Budapest (HU); István Maros, Budapest (HU)

(21) Appl. No.: 13/421,386

(22) Filed: Mar. 15, 2012

(51) Int. Cl. H05B 37/02

(52) U.S. Cl. 315/154

(57) ABSTRACT

The present subject matter is directed to a lighting control system and method. Motion or occupancy sensors are used to determine when a lighting fixture and/or a nearby lighting fixture should be activated. A controller associated with each lighting fixture switches its lighting fixture on and triggers a communications circuit to generate and send a signal to nearby lighting fixtures when a user is detected. Each lighting fixture also has a signal receiver to receive signals from any nearby lighting fixtures that are configured to communicate with it via a communication circuit. The present subject matter allows for a significant amount of energy to be saved as remote areas away from an occupied area do not have to be illuminated. Meanwhile, the user is still provided with a comfortable level of lighting in and near the occupied area.

### BACKGROUND OF THE INVENTION

A. Field of the Invention

The present subject matter relates to lighting. More particularly, the present subject matter relates to a lighting control system and method.

B. Description of Related Art

In large buildings or outdoor spaces, it is often desirable to provide a control system for the lighting in the building or outdoor space in order to reduce energy costs. Currently, lighting in an area such as a corridor or room, can be controlled by various means such as from a central location, by remote control, or by motion detection. Centrally located lighting control systems can require the integration of sensors and lighting drivers into a dedicated analogue/digital/communications system such as can be implemented by the digital addressable lighting interface (DALI) protocol. This often requires rewiring of a facility, which can be time-consuming, disruptive to operations, and expensive. Additionally, once the lighting control system is installed, commissioning and maintenance are required, and this can be expensive and involves special expertise. Moreover, the lighting control may not be automatic and requires input in order to control the luminosity in a room. Further, although wireless communication systems can be installed, the lighting control is still not automatic.

Additionally, lighting in an area can be controlled by a remote control, but this requires user input as well, and is also not automatic. Thus, energy savings are not likely to be great. Motion sensors can also be used to control lighting in an area to save energy, but such a system can be characterized by abrupt on and off cycles that do not provide continuous light to an area where a user is present, such as when the user is at the border of the detection area of one of the motion sensors. Therefore, while the use of a centrally located lighting control system, a remote lighting control system, or motion detector system can provide for some energy savings, a lighting control system that is more energy efficient, that does not require total rewiring of an area, that does not require expensive maintenance, and that does not have abrupt on and off cycles would be beneficial.

### BRIEF DESCRIPTION OF THE INVENTION

Aspects and advantages of the invention will be set forth in part in the following description, or may be apparent from the description, or may be learned through practice of the invention.

One exemplary aspect of the present disclosure is directed to a lighting system for controlling illumination of a first area and a second area. The lighting system can include a first lighting fixture located at (or in) the first area. The first lighting fixture can include a first sensor and a controller. The first sensor can be configured to detect the presence of a user in the first area. The lighting system can also comprise a second lighting fixture located at (or in) the second area and a communication circuit configured to provide for communication between the first lighting fixture and the second lighting fixture. Upon detection of the presence of a user in the first area the controller can be configured to illuminate the first lighting fixture and send a signal to trigger illumination of the second lighting fixture.

Another exemplary aspect of the present disclosure is directed to a method for controlling illumination of a first lighting fixture and a second lighting fixture. The method includes monitoring for the presence of a user in a first detection area with a first sensor. Upon detection of the presence of a user in the first detection area by the first sensor, the method includes illuminating the first lighting fixture, and sending a signal from the first lighting fixture to the second lighting fixture to trigger the illumination of the second lighting fixture.

A further exemplary aspect of the present disclosure is directed to a lighting fixture. The lighting fixture can include a lighting source, a sensor configured to detect the presence of a user in a detection area, and a controller. Upon detection of a user in the detection area, the controller can be configured to illuminate the lighting source and generate a signal to trigger the illumination of a second lighting fixture.

Variations and modifications can be made to these exemplary embodiments of the present disclosure.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a block diagram of a lighting fixture of a lighting control system according to an exemplary embodiment of the present disclosure;

FIG. 2 is a block diagram of a lighting fixture of a lighting control system according to an exemplary embodiment of the present disclosure;

FIG. 3 is a flow chart of a method for controlling illumination of a plurality of lighting fixtures according to an exemplary embodiment of the present disclosure;

FIG. 4 is a side view of a lighting system based on a first occupancy scenario according to an exemplary embodiment of the present disclosure;

FIG. 5 is a side view of a lighting system based on a second occupancy scenario according to an exemplary embodiment of the present disclosure;

FIG. 6 is a side view of a lighting system based on a third occupancy scenario according to an exemplary embodiment of the present disclosure;

FIG. 7 is a top view of a lighting system based on a first occupancy scenario according to an exemplary embodiment of the present disclosure;

FIG. 8 is a top view of a lighting system based on a second occupancy scenario according to an exemplary embodiment of the present disclosure;

FIG. 9 is a top view of a lighting system based on a third occupancy scenario according to an exemplary embodiment of the present disclosure;

FIG. 10 is a top view of a lighting system based on a fourth occupancy scenario according to an exemplary embodiment of the present disclosure; and

FIG. 11 is a top view of a lighting system based on a fifth occupancy scenario according to an exemplary embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure relates to an occupancy or motion-based dynamic lighting control system and method. The system can include at least two lighting fixtures that can communicate with each other over a wireless communication channel and/or network using infrared, BLUETOOTH®, or similar forms of wireless transmission and reception. Such an integrated design can be simple and low cost without the need for a central control system. The design can also be expandable without limit, does not require new wiring or device commissioning, allows for automatic power saving in large rooms or outdoors, and provides for maximum user comfort, without rapid switch on and off cycles that can be disturbing to a user.

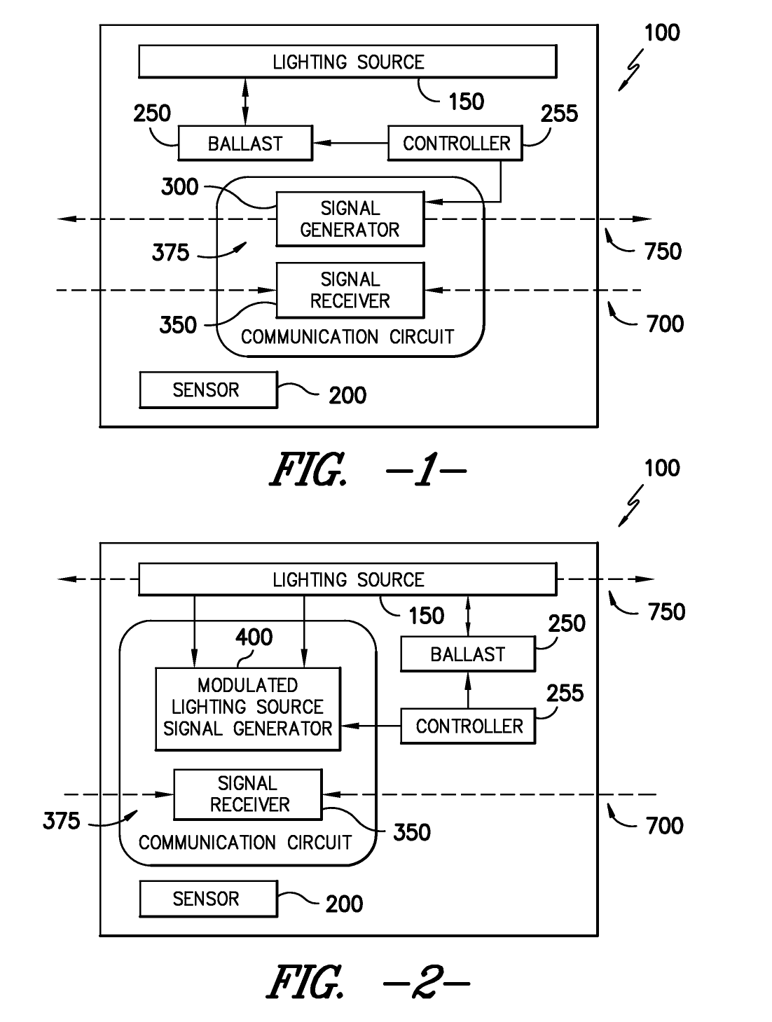

FIG. 1 depicts a lighting fixture 100 that can be used as part of a lighting system for dynamic lighting control according to an exemplary embodiment of the present disclosure. The lighting fixture 100 has a lighting source 150, a sensor 200, a ballast 250, a controller 255, a signal generator 300, and a signal receiver 350. The signal generator 300 and signal receiver 350 can each be a part of a communication circuit with nearby lighting fixtures (not shown). The lighting source 150, for example, can be instant on and can be a fluorescent tube, a white light emitting diode (LED), an LED array that combines white and red LEDs, a combination of fluorescent tubes and LEDs. The lighting fixture could also include other suitable lighting sources, such as high intensity discharge lamps, including ceramic metal halide lamps, or any other suitable lighting source.

The sensor 200 is used to determine if a user is located in a detection area corresponding to the sensor so that the illumination of the lighting source can be triggered or initiated. The sensor 200 can be a motion sensor or an occupancy sensor. Motion sensors respond to walking or other movements. Motion sensors can perceive movements in the selected detection zone and respond to them. A lighting source 150 can be controlled to turn on upon detection of movement by the motion sensor. The lighting source 150 can be controlled switches that turn off after no movement is detected for a period of time. The use of motion detectors or sensors can be preferable for detecting moving objects outdoors or in corridors indoors, where there is more likely to be constant movement that is detected.

The sensor 200 can also be an occupancy sensor. Occupancy sensors detect the presence of a user in an area instead of detecting movements. Thus, occupancy sensors can be more effective in areas such as offices where the user is more sedentary, as opposed to areas such as corridors where more movement is occurring. Numerous types of occupancy sensors exist, including passive infrared (PIR) occupancy sensors, active ultrasonic occupancy sensors, dual-technology passive infrared and active ultrasonic occupancy sensors, dual-technology passive infrared and microphonic occupancy sensors, and other suitable sensors. A technical effects associated with embodiments of the invention is that such an arrangement provides sufficient illumination but can save significant energy because remote areas are not lit. Another technical effect is that when the user moves through a space having multiple lighting fixtures that detect the user's presence and/or movement and communicate with each other, the lit area can follow the user.

The lighting fixture 100 can also include a ballast 250 to regulate the power provided to the lighting source 150. In general, ballasts stabilize the current through an electrical load to provide the proper power to the lighting source. The ballast 250 can be used to ensure the proper current is provided to power fluorescent lamps, high-intensity discharge lamps, or other lamps used as lighting source 150.

Controller 255 control illumination of the lighting fixture through control of the ballast. Upon receipt of a signal from the sensor 200 indicating the presence of a user in a detection area, the controller 255 can send a signal to the ballast 250 and/or lighting source 150 to trigger illumination of the lighting source 150. The controller 255 can be any suitable control device, such as a microcontroller, processor, control circuit, or other suitable control device.

As shown in FIG. 1, the lighting fixture 100 can also include a communication circuit 375. The communication circuit 375 can include a signal generator 300 and a signal receiver 350. The signal generator 300 can be its own, dedicated component and can be used to send a signal to a second lighting fixture to trigger the illumination of the second lighting fixture. In particular, the controller 255, which illuminates the lighting fixture 100 upon the detection of the presence of a user by the sensor 100, can also control the signal generator to send a signal to a nearby second lighting fixture to trigger its illumination. The signal generator 300 can send an optical, infrared, ultrasonic, radio frequency, or hard-wired signal to the second lighting fixture. The signal receiver 350 of FIG. 1 is used to receive signals generated from signal generators associated with other lighting fixtures in the area. Upon receipt of a signal from another lighting fixture, the controller 255 can illuminate the lighting source 150.

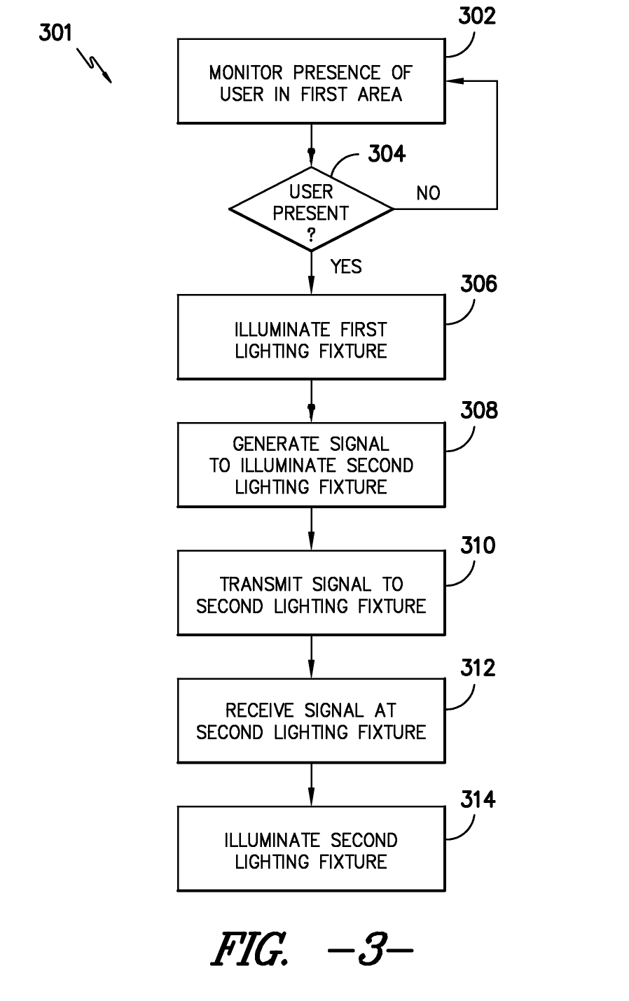

FIG. 2 depicts a lighting fixture according to another embodiment of the present disclosure. The lighting fixture depicted in FIG. 2 is similar to the lighting fixture of FIG. 1. In the embodiment of FIG. 2, however, the signal generator that is part of communication circuit 375 is not a dedicated device as described in FIG. 1. Rather, the signal generator includes modulated lighting source signal generator 400. The modulated lighting source signal generator 400 is configured to modulate the light emitted from the lighting source 150 at a specified frequency. Preferably, the specified frequency is beyond a frequency modulation detectable by a human eye, such as greater than about 50 Hz. A second lighting fixture is configured to detect the modulated light from the first lighting fixture and trigger the illumination of a second lighting fixture based on the modulated light. In this manner, the lighting control system does not required dedicated communication devices for sending signals between fixtures.

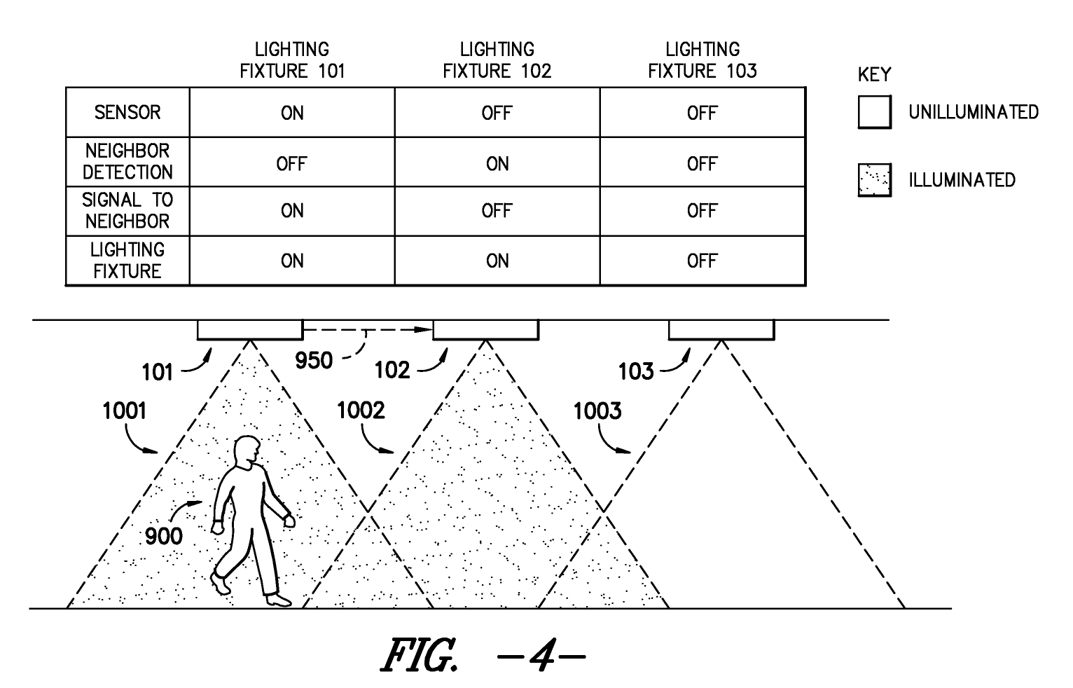

FIG. 3 depicts a flow chart of an exemplary method 300 for dynamically controlling lighting in an indoor or outdoor space through use of a lighting system that covers at least two areas and has at least two lighting fixtures. The method involves controlling the lighting by monitoring for the presence of a user in a first area (302) using a sensor. If a user is not detected as present in the first area (304), the system continues monitoring for the presence of a user in the first area (302) until a user is detected. If a user is detected as present in the first area (304), the first lighting fixture is illuminated (306) via a controller associated with the first lighting fixture. Next, a signal is generated to illuminate the second lighting fixture (308), and this signal is then transmitted to the second lighting fixture (310) via a communication circuit. The signal can then be received by the second lighting fixture (312), and then the second lighting fixture is illuminated (314) via its controller. The method can also include monitoring for the presence of a user in a second area with a second sensor in the same manner as described above for monitoring the first area.

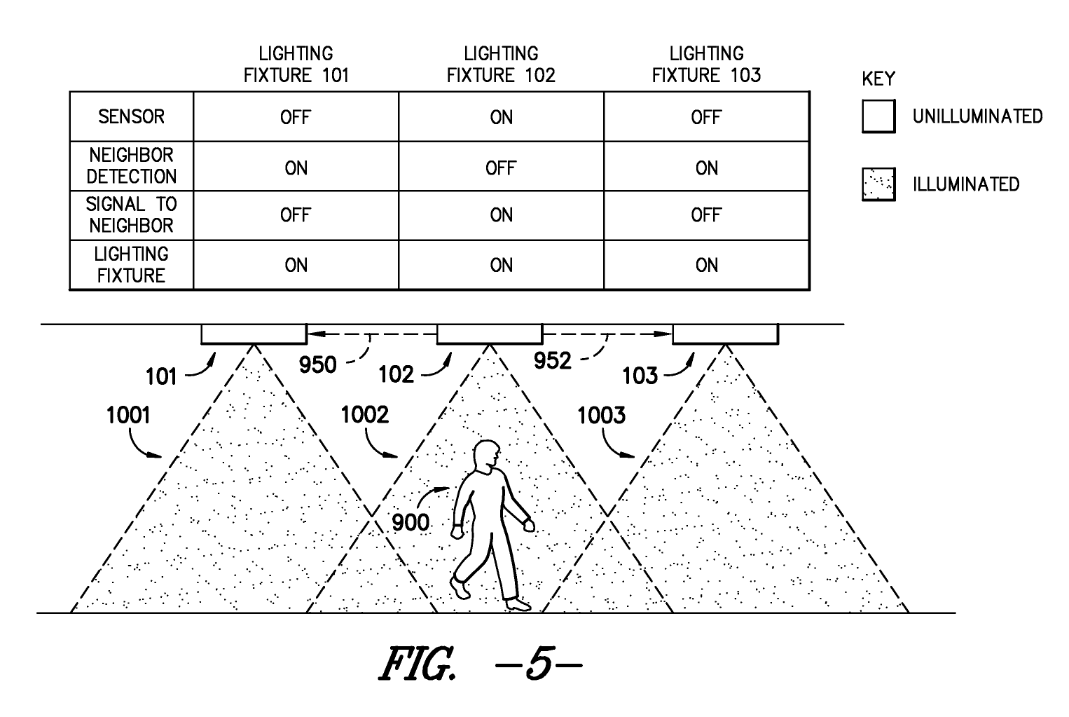

An exemplary illustration of the operation of a lighting system will now be discussed with reference to FIGS. 4-11. FIGS. 4-6 represent side views of a lighting system that includes three lighting fixtures 101, 102, and 103 based on three different occupancy scenarios as a user progresses through a space, which could be a hallway, office or outdoor space, for example. Based on the logic shown below in Table 1, a lighting fixture can be illuminated based on the detection of a user in various areas:

TABLE 1
Control Logic

| | Input | | Output | |
|---|---|---|---|---|
| | | Neighbor | Signal to | Lighting Fixture |
| Scenario | Sensor | Detection | Neighbor | Status |
| 1 | ON | OFF | ON | ON |
| 2 | OFF | ON | OFF | ON |
| 3 | OFF | OFF | OFF | OFF |
| 4 | ON | ON | ON | ON |

For example, in scenario 1, if a lighting fixture's sensor detects a user in the view angle of the sensor, the sensor is “on.” Because the sensor is “on,” the lighting fixture status output is “on,” indicating the lighting fixture is illuminated. Because the sensor is on, a signal is also sent to a neighboring or nearby lighting fixture, as shown by the signal to neighbor output being “on.” The signal is sent to the neighboring area's lighting fixture via a communication circuit so that the lighting fixture in the nearby area can then be illuminated by its controller. Additionally, as shown by the neighbor detection input being “off,” a user is not present in a nearby or neighboring area.

In scenario 2, if a sensor does not detect a user in the detection area or view angle area below its lighting fixture, the sensor input will be “off” and it will not send a signal to a neighboring lighting fixture. Thus, the signal to neighbor input is also “off”. However, if the neighboring lighting fixture's sensor detects a user in the neighboring area, the lighting fixture is still illuminated or turned on, as shown by the neighbor detection input being “on” and the lighting fixture status being “on.” Thus, as shown in scenarios 1 and 2 above, there are at least two ways in which a single lighting fixture can be illuminated: (1) by a neighboring lighting fixture detecting a user in its area and sending a signal to the lighting fixture and (2) the lighting fixture detecting a user in its own area, triggering illumination.

Meanwhile, scenario 3 shows that if a sensor does not detect a user in the lighting fixture's detection area, as shown by the sensor being “off,” the lighting fixture will not be illuminated and no signal will be sent to a neighboring lighting fixture, as shown by the neighbor detection input being “off”. Additionally, if there is no neighboring lighting fixture that detects a user in its area, as shown by the neighbor detection input being “off,” then the lighting fixture will remain “off.”

Lastly, scenario 4 shows the situation where a lighting fixture's sensor detects a user in its area, as shown by the sensor being “on,” so that the lighting fixture is sending a signal to a neighboring or nearby lighting fixture, as shown by the signal to neighbor output being “on.” Additionally, the lighting fixture is receiving a signal from a nearby lighting fixture that a user is present in the neighboring lighting fixture's detection area, as shown by the neighbor detection input being “on.” In this scenario where a user is detected in the detection area of the lighting fixture and a user is detected in a neighboring area, the lighting fixture is illuminated, as shown by the lighting fixture status output being “on.”

In one embodiment, the logic in Table 1, and/or modifications and/or equivalents thereof, may be stored in a computer-readable medium in the form of computer-readable instructions that when executed by a processor cause one or more of the steps 302, 304, 306, 308, 310, 312 and 314 (FIG. 3) to be performed by one or more lighting fixtures 100 (FIG. 1).

Turning to FIG. 4, the logic of Table 1 above can be applied to an everyday situation of walking in a room or outdoor space. In FIG. 4, three lighting fixtures are shown, 101-103. Although it appears in FIG. 4 that the lighting fixtures are adjacent to each other, they can be spaced apart or across the room from each other so long as the signals generated from each lighting fixture can be received by the other lighting fixtures via a communication circuit. As shown in FIG. 4, a user 900 is present within the view angle (or detection area) 1001 of the sensor associated with lighting fixture 101. Thus, the sensor associated with lighting fixture 101 detects a user and is “on,” meaning the controller associated with lighting fixture 101 triggers the illumination of its lighting source. Because no user 900 is present within the view angle (or detection area) 1002 of the sensor associated with lighting fixture 102 or the view angle (or detection area) of 1003 of the sensor associated with lighting fixture 103, the sensors that would be used detect the presence of a user to illuminate lighting fixture 102 and lighting fixture 103 are “off.” Thus, only lighting fixture 101 is illuminated or “on” due to the presence of a user in the area associated with the lighting fixture. However, lighting fixture 102 is illuminated as well, due to the presence of user 900 in its neighbor's area, namely the area associated with lighting fixture 101, as shown in FIG. 4 where lighting fixture 102 neighbor detection is “on.”

Although it is possible to have communication with more than one lighting fixture, as will be shown in subsequent figures, lighting fixture 101 is only configured to communicate with lighting fixture 102, not lighting fixture 103. Because a user 900 is present in the area associated with lighting fixture 101, the signal generator (not shown) associated with lighting fixture 101 is activated by its controller so that it generates a signal 950. This signal 950 triggers the illumination of its neighboring lighting fixture 102, which receives the signal 950 sent by lighting fixture 101. The controller associated with neighboring lighting fixture 102 then turns on or activates its lighting source. Because a lighting fixture configured to communicate with lighting fixture 103 has not detected a user in order to trigger the generation and sending of a signal to lighting fixture 103, nor has lighting fixture 103 detected a user in its detection area lighting fixture 103 remains switched off. Note that although the term “switched off” can mean that the lighting fixture is turned off or unlit, it can also mean that the lighting fixture is on, but in a dimmed lighting state.

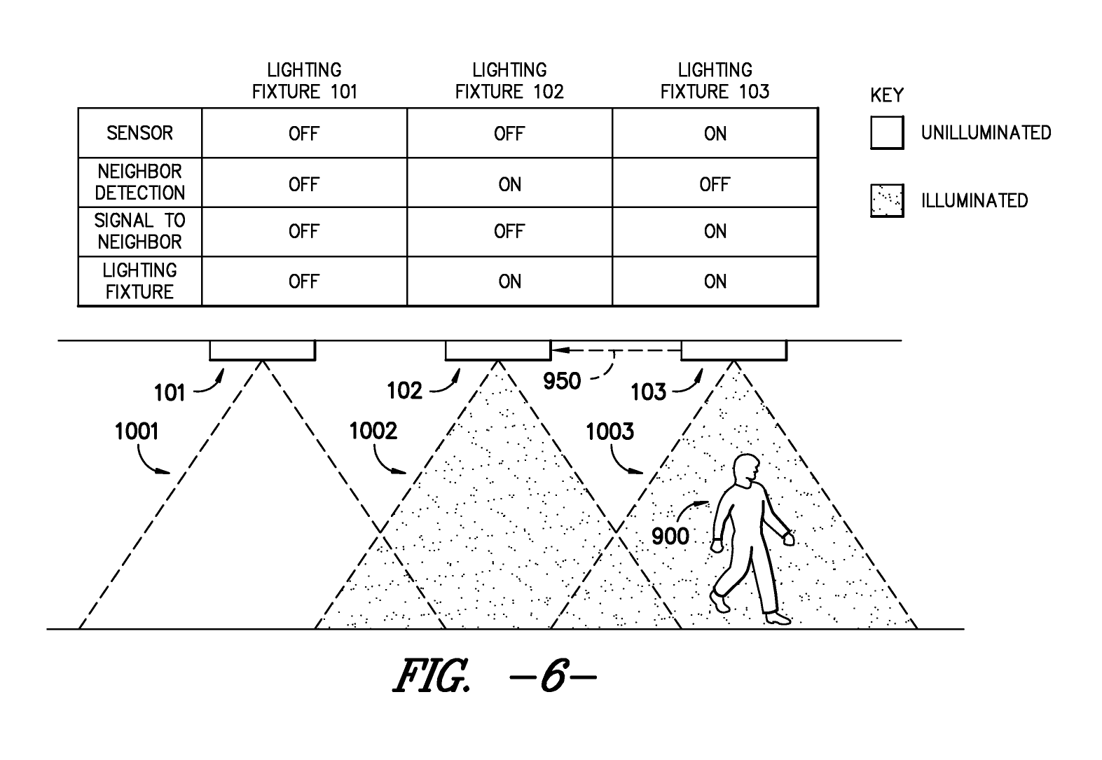

FIG. 5 shows a side view of a lighting system based on a second occupancy scenario. Now, the user 900 is standing under lighting fixture 102, which corresponds to sensor detection area or view angle 1002. Because the sensor associated with lighting fixture 102 has detected a user in its detection area, the controller associated with lighting fixture 102 triggers the illumination of its lighting source. Note that a user 900 is not present in view angle/detection area 1001 or view angle/detection area 1003, so lighting fixtures 101 and 103 are not illuminated based on the presence of a user 900 in their respective detection areas. The sensor associated with lighting fixture 102 is on, however, due to the presence of user 900 in detection area or view angle 1002. Thus, the controller associated with lighting fixture 102 initiates the generation of a signal 950 that is sent to lighting fixture 101, while signal 952 is generated and sent to lighting fixture 103, as both lighting fixtures 101 and 103 are configured to communicate with lighting fixture 102 via a communication circuit. Although neither sensor associated with lighting fixture 101 or 103 is on because no user is present in their view angles of 1001 and 1003, respectively, the signals 950 and 952 sent from lighting fixture 102 trigger the illumination of both lighting fixtures 101 and 103. Thus, the user 900 is surrounded by light on each side of the lighting fixture 102 under which the user stands, which provides for a comfortable environment, while also saving energy, as nearby lighting fixtures not configured to communicate with lighting fixture 102 remain off or unlit.

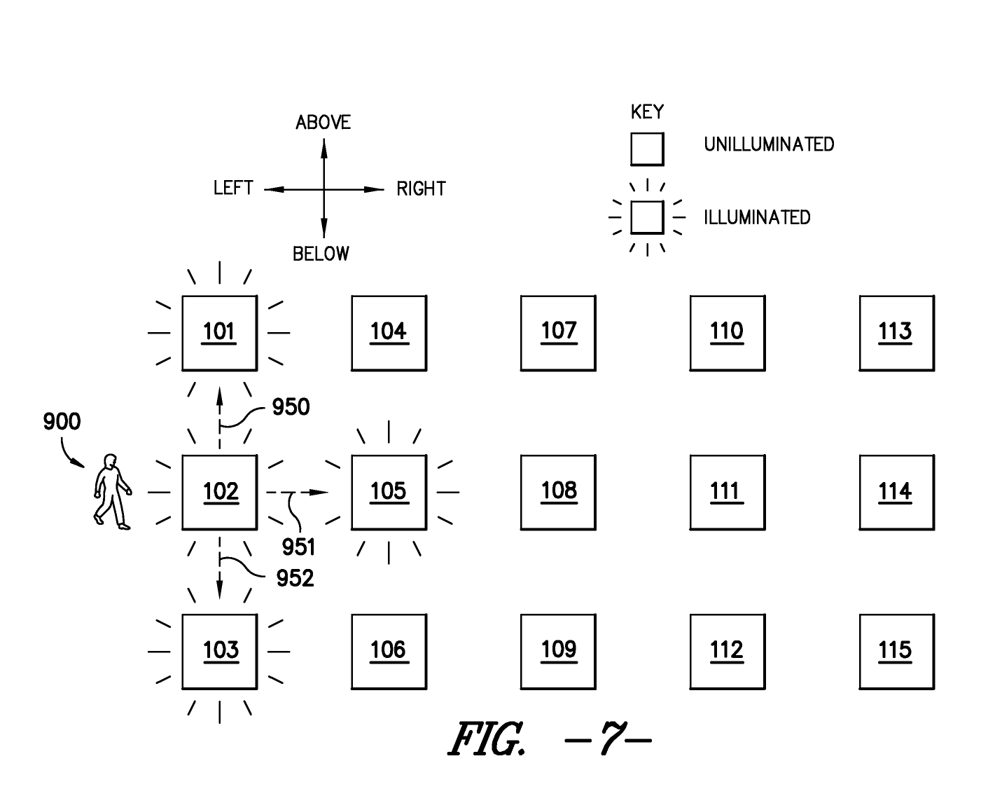

Next, FIG. 6 shows a side view of a lighting system as the user 900 has progressed farther to the right in the space. Now, user 900 is standing under lighting fixture 103, within view angle/detection area 1003, so that the sensor associated with lighting fixture 103 detects the user 900's presence, thus illuminating lighting fixture 103 via its controller. Additionally, lighting fixture 103 is configured to communicate via a communication circuit with lighting fixture 102. Thus, the controller associated with lighting fixture 103 triggers the generation and sending of a signal 950 via the communication circuit to trigger the illumination of lighting fixture 102 by its controller. Note that lighting fixture 101 is not illuminated because it has not received a signal from lighting fixture 103 as they are not configured to communicate with each other via a communication circuit. It could be possible, however, to transmit a signal from lighting fixture 103 to lighting fixture 101 if desired.

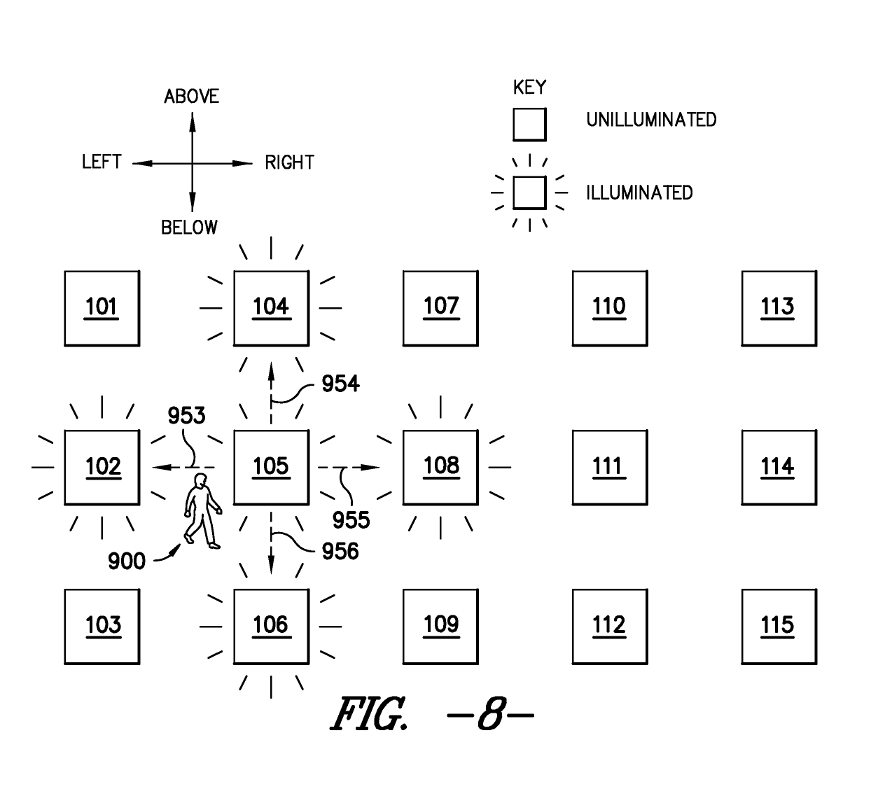

FIGS. 7, 8, 9, 10 and 11 show a progression of illuminated lighting fixtures as a user 900 moves from left to right across a room, corridor, or outdoor space. FIG. 7 is a top view of a lighting system based on a first occupancy scenario where the user 900 is farthest to the left of the space. The user 900 is standing under lighting fixture 102, which is configured to communicate via a communication circuit that can generate and send signals to lighting fixture 101 above, lighting fixture 105 to the right, and lighting fixture 103 below. Once the user 900 is detected by the sensor (not shown) associated with lighting fixture 102, lighting fixture 102 is illuminated via its controller. The controller then triggers the communication circuit to generate a signal to nearby or neighboring lighting fixtures that are configured to communicate with lighting fixture 102 via the circuit. Thus, signal 950 is sent to lighting fixture 101, signal 951 is sent to lighting fixture 105, and signal 952 is sent to lighting fixture 103. Once these signals 950, 951, and 952 are received, the lighting fixtures associated with them are illuminated via their respective controllers. This provides for a well-lit space around user 900 as he travels across the space, while at the same time saving energy, as lighting fixtures 104 and 106-115 in the room remain off or dimmed.

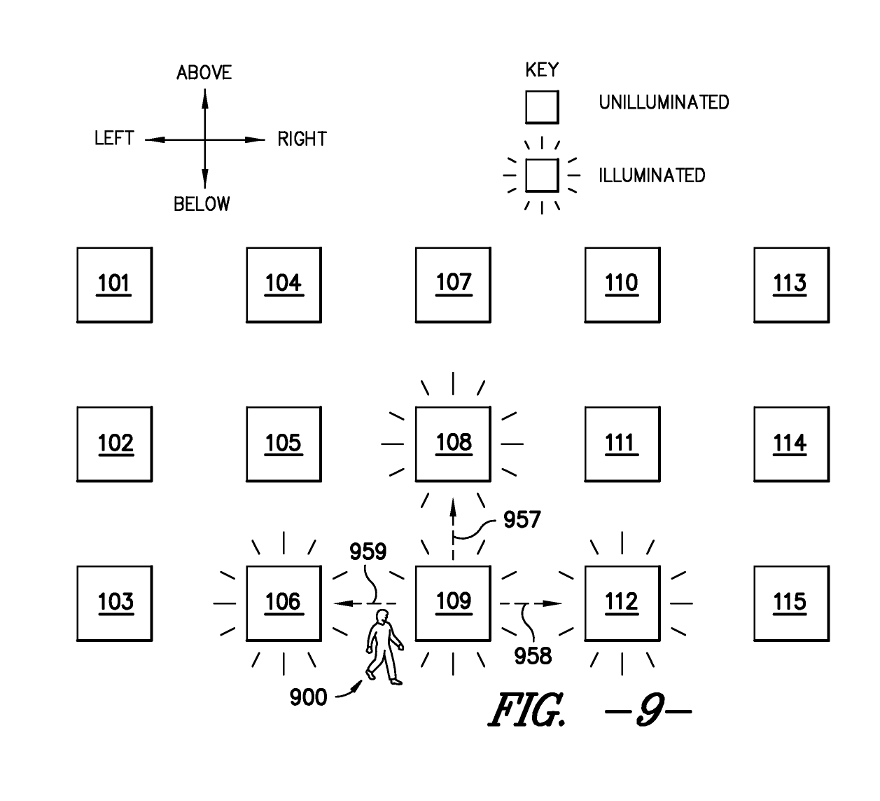

Next, FIG. 8 is a top view of a lighting system based on a second occupancy scenario. Now, the user has traveled further into the space (to the viewer's right in FIG. 8), and the lighting fixture 105 under which the user stands is configured to communicate with neighboring lighting fixture 102 to its left, neighboring lighting fixture 104 above, neighboring lighting fixture 108 to its right, and neighboring lighting fixture 106 below. Once the sensor associated with lighting fixture 105 detects the user 900, lighting fixture 105 is illuminated via its controller. The controllerthen triggers the communication circuit to generate and send signals to the nearby or neighboring lighting fixtures that have been configured to communicate with lighting fixture 105. Thus, signal 953 is sent to lighting fixture 102, signal 954 is sent to lighting fixture 104, signal 955 is sent to lighting fixture 108, and signal 956 is sent to lighting fixture 106. Once signals 953, 954, 955, and 956 are received, the lighting fixtures associated with them are illuminated via their respective controllers, although no user 900 is detected in their sensors' view angles/detection areas. Again, this provides for a well-lit space around user 900 as he/she travels across the space, while at the same time saving energy, as lighting fixtures 101, 103, 107, and 109, 110, 111, 112, 113, 114 and 115 in the room remain unlit, switched off, or dimmed.

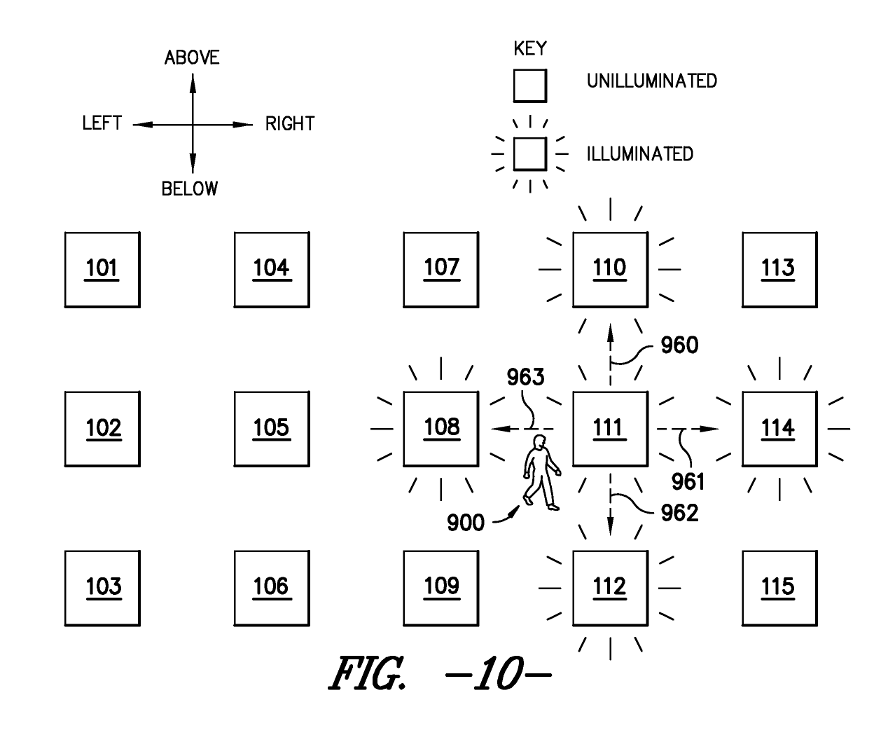

FIG. 9 is similar to FIGS. 7-8 described above, although the user 900 has moved to the right and down one area in the space. The lighting fixture 109 under which he stands is configured to communicate with lighting fixture 106 to the left, lighting fixture 108 above, and lighting fixture 112 to the right. Once the user 900 is detected by the sensor associated with lighting fixture 109, lighting fixture 109 is illuminated via its controller. The controller then triggers lighting fixture 109's communication circuit to generate and send signals to the nearby or neighboring lighting fixtures that have been configured to communicate with lighting fixture 109. Thus, signal 957 is sent to lighting fixture 108, signal 958 is sent to lighting fixture 112, and signal 959 is sent to lighting fixture 106. Once signals 957, 958, and 959 are received, the lighting fixtures associated with them are illuminated via their respective controllers, although no user 900 is detected in their sensors' view angles/detection areas. Again, this provides for a well-lit space around user 900 as he travels across the space, while at the same time saving energy, as lighting fixtures 101-105, 107, 110-111, and 113-115 in the room remain unlit, switched off, or dimmed.

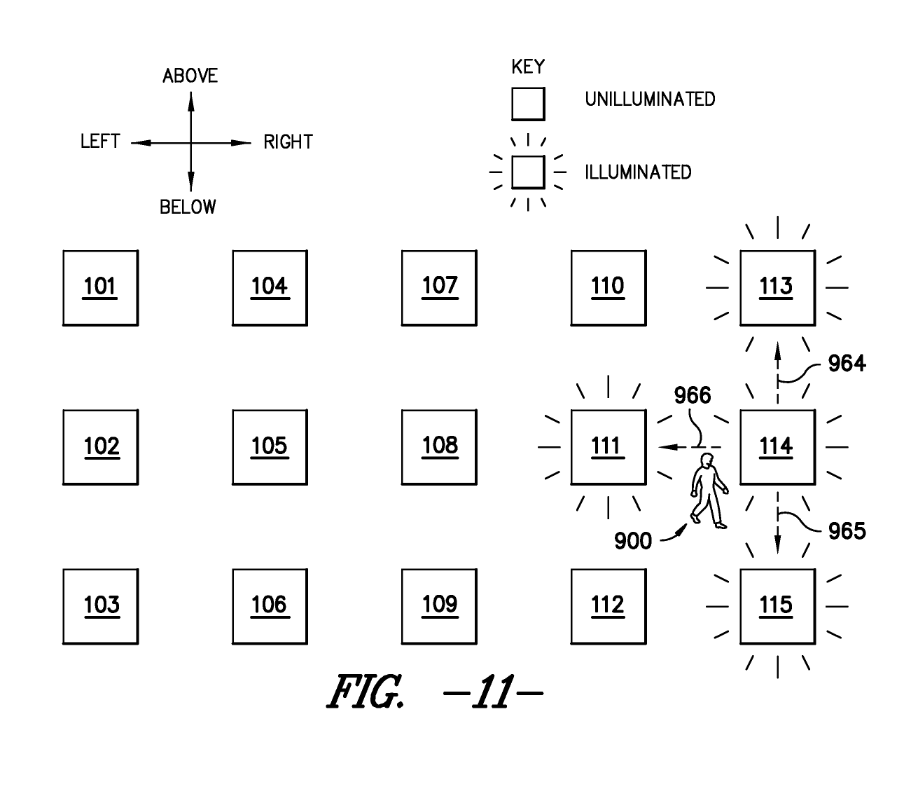

FIG. 10 represents a top view of a lighting system based on a fourth occupancy scenario. The user 900 has now moved to the right and up once space compared to FIG. 9. The lighting fixture 111 under which the user stands is configured to communicate with neighboring lighting fixture 108 to the left, neighboring lighting fixture 110 above, neighboring lighting fixture 114 to the right, and neighboring lighting fixture 112 below. Once the user 900 is detected by the sensor associated with lighting fixture 111, lighting fixture 111 is illuminated via its controller. The controller then triggers lighting fixture 111's communication circuit to generate and send signals to the nearby or neighboring lighting fixtures that have been configured to communicate with lighting fixture 111. Thus, signal 960 is sent to lighting fixture 110, signal 961 is sent to lighting fixture 114, signal 962 is sent to lighting fixture 112, and signal 963 is sent to lighting fixture 108. Once signals 960, 961, 962, and 963 are received, the lighting fixtures associated with them are illuminated via their respective controllers, although no user 900 is detected in their sensors' view angles/detection areas. Again, this provides for a well-lit space around user 900 as he/she travels across the space, while at the same time saving energy, as lighting fixtures 101-107, 109, 113, and 115 in the room remain unlit, switched off, or dimmed.

FIG. 11 is a top view of a lighting system based on a fifth occupancy scenario where user 900 has moved to the right one space. The lighting fixture 114 under which he stands is configured to communicate with lighting fixture 111 to the left, lighting fixture 113 above, and lighting fixture 115 below. Once the user 900 is detected by the sensor associated with lighting fixture 114, lighting fixture 114 is illuminated via its controller. The controller then triggers the communication circuit associated with lighting fixture 114 to generate and send signals to the nearby or neighboring lighting fixtures that have been configured to communicate with lighting fixture 114 via the circuit. Thus, signal 964 is sent to lighting fixture 113, signal 965 is sent to lighting fixture 115, and signal 966 is sent to lighting fixture 111. Once signals 964, 965, and 966 are received, the lighting fixtures associated with them are illuminated via their respective controllers, although no user 900 is detected in their sensors' view angles/detection areas. Again, this provides for a well-lit space around user 900 as he travels across the space, while at the same time saving energy, as lighting fixtures 101-110 and 112 in the room remain unlit, switched off, or dimmed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A lighting system to control illumination of a first area and a second area, the lighting system comprising:
a first lighting fixture located at the first area, the first lighting fixture comprising a first sensor and a controller coupled with the first sensor, the first sensor configured to detect the presence of a user in the first area;
a second lighting fixture located at the second area; and
a communication circuit configured to provide for communication between the first lighting fixture and the second lighting fixture;
wherein upon detection of the presence of a user in the first area, the controller is configured to illuminate the first lighting fixture and send a signal to trigger illumination of the second lighting fixture.

2. A lighting system as in claim 1, wherein the second lighting fixture further comprises a second sensor and a controller, the second sensor configured to detect the presence of a user in the second area; wherein upon detection of the presence of a user in the second area, the controller is configured to illuminate the second lighting fixture and send a signal to trigger illumination of the first lighting fixture.

3. A lighting system as in claim 1, wherein the second area is adjacent to the first area.

4. A lighting system as in claim 2, wherein the first sensor and the second sensor are occupancy sensors or motion sensors.

5. A lighting system as in claim 1, wherein the communication circuit comprises a signal generator associated with the first lighting fixture and a signal receiver associated with the second lighting fixture, wherein the signal receiver is configured to receive a signal sent from the signal generator.

6. A lighting system as in claim 2, wherein the communication circuit comprises a first signal generator and a first signal receiver associated with the first lighting fixture, and a second signal generator and a second signal receiver associated with the second lighting fixture, wherein the second signal receiver is configured to receive a signal sent from the first signal generator and the first signal receiver is configured to receive a signal sent from the second signal generator.

7. A lighting system as in claim 5, wherein the signal generator comprises an infrared, optical, ultrasonic, radio frequency, or hard-wired signal generator.

8. A lighting system as in claim 5, wherein the signal generator comprises a modulated lighting source of the first lighting fixture.

9. A lighting system as in claim 8, wherein the signal receiver is configured to detect modulated light from the first lighting fixture.

10. A lighting system as in claim 1, wherein the first and second lighting fixtures comprise fluorescent tubes, light emitting diodes, or high intensity discharge lamps.

11. A method for controlling illumination of a first lighting fixture and a second lighting fixture, the method comprising:
monitoring for the presence of a user in a first detection area with a first sensor; and
upon detection of the presence of a user in the first detection area by the first sensor, illuminating the first lighting fixture; and
sending a signal from the first lighting fixture to the second lighting fixture to trigger the illumination of the second lighting fixture.

12. A method as in claim 11, the method further comprising:
monitoring for the presence of a user in a second detection area with a second sensor; and
upon detection of the presence of a user in the second detection area by the second sensor, illuminating the second lighting fixture; and
sending a signal from the second lighting fixture to the first lighting fixture to trigger illumination of the first lighting fixture.

13. A method as in claim 11, wherein the second detection area is adjacent to the first detection area.

14. A method as in claim 11, wherein sending a signal from the first lighting fixture to the second lighting fixture comprises:
generating a signal at a signal generator associated with the first lighting fixture; and
receiving the signal at a signal receiver associated with the second lighting fixture.

15. A method as in claim 11, wherein the signal comprises an optical, infrared, ultrasonic, radio frequency, or hard-wired signal.

16. A method as in claim 11, wherein the signal comprises modulated light from the first lighting fixture.

17. A method as in claim 16, wherein the second lighting fixture is configured to detect modulated light from the first lighting fixture.

18. A lighting fixture, comprising:
a lighting source;
a sensor configured to detect the presence of a user in a detection area; and
a controller coupled with the lighting source and the sensor;
wherein upon detection of a user in the detection area the controller is configured to illuminate the lighting source and generate a signal to trigger the illumination of a second lighting fixture.

19. A lighting fixture as in claim 18, wherein the signal comprises an optical, infrared, ultrasonic, radio frequency or hard-wired signal.

20. A lighting fixture as in claim 18, wherein the signal comprises modulated light.
